(19) United States
(12) Patent Application Publication
(10) Pub. No.: US 2025/0100473 A1
(43) Pub. Date: Mar. 27, 2025

(54) ROUTING STRUCTURE

(71) Applicant: YAZAKI CORPORATION, Tokyo (JP)

(72) Inventors: Kosuke Tomosada, Makinohara-shi (JP); Naoto Kogure, Makinohara-shi (JP)

(21) Appl. No.: 18/892,314

(22) Filed: Sep. 20, 2024

(30) Foreign Application Priority Data
Sep. 26, 2023 (JP) 2023-163172

(51) Int. Cl. B60R 16/02; B60J 7/043; B60R 16/03

(52) U.S. Cl. CPC B60R 16/0215; B60R 16/03; B60J 7/043

(57) ABSTRACT

A routing structure includes a first fixing portion, a second fixing portion, an exterior member having a first end portion, a second end portion, and a curved portion, an electric wire, and a regulating unit, wherein the second fixing portion holds the second end portion such that the exterior member extends from the second fixing portion along a slide body in the predetermined direction, the regulating unit regulates separation of a portion, of the exterior member, extending along the slide body from the slide body, and the regulating unit applies, to the exterior member, at least one of a pressing force, the pressing force pressing the exterior member against the slide body and a holding force that holds the exterior member on the slide body.

### CROSS-REFERENCE TO RELATED APPLICATION(S)

The present application claims priority to and incorporates by reference the entire contents of Japanese Patent Application No. 2023-163172 filed in Japan on Sep. 26, 2023.

### BACKGROUND OF THE INVENTION

### 1. Field of the Invention

The present invention relates to a routing structure.

### 2. Description of the Related Art

In the related art, there is a power feeding device for a slide body. Japanese Patent Application Laid-open No. 2011-151906 discloses a power feeding device for a slide body including a wire harness routed over a vehicle body and a slide body that is slidably provided in the vehicle body and opens and closes an opening formed in the vehicle body.

When the routing structure between the vehicle body and the slide body includes an exterior member, it is desirable that the shape of the exterior member is stable. For example, the exterior member is held by the slide body and the vehicle body in a state of having a curved portion curved in a sliding direction of the slide body. When the bending R of the curved portion changes according to the movement of the slide body, the shape of the exterior member may be unstable due to vibration or its own weight.

### SUMMARY OF THE INVENTION

An object of the present invention is to provide a routing structure capable of stabilizing a shape of an exterior member.

In order to achieve the above mentioned object, a routing structure according to one aspect of the present invention includes a first fixing portion fixed to a vehicle body of a vehicle; a second fixing portion fixed to a slide body that slides along a predetermined direction with respect to the vehicle body; an exterior member having a first end portion held by the first fixing portion, a second end portion held by the second fixing portion, and a curved portion curved in the predetermined direction between the first end portion and the second end portion; an electric wire disposed inside the exterior member; and a regulating unit, wherein the second fixing portion holds the second end portion such that the exterior member extends from the second fixing portion along the slide body in the predetermined direction, the regulating unit regulates separation of a portion, of the exterior member, extending along the slide body from the slide body, and the regulating unit applies, to the exterior member, at least one of a pressing force generated by a magnetic force, the pressing force pressing the exterior member against the slide body and a holding force that holds the exterior member on the slide body.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a side view of a routing structure according to a first embodiment;

FIG. 2 is a side view of the routing structure according to the first embodiment;

FIG. 3 is a cross-sectional view of the routing structure according to the first embodiment;

FIG. 4 is a cross-sectional view of the routing structure according to a second embodiment;

FIG. 5 is a side view of the routing structure according to the second embodiment; and

FIG. 6 is a cross-sectional view of another routing structure according to the second embodiment.

### DETAILED DESCRIPTION OF THE PREFERRED EMBODIMENTS

Hereinafter, a routing structure according to an embodiment of the present invention will be described in detail with reference to the drawings. Note that the present invention is not limited by the embodiment. In addition, constituent elements in the following embodiments include those that can be easily assumed by those skilled in the art or those that are substantially the same.

### First Embodiment

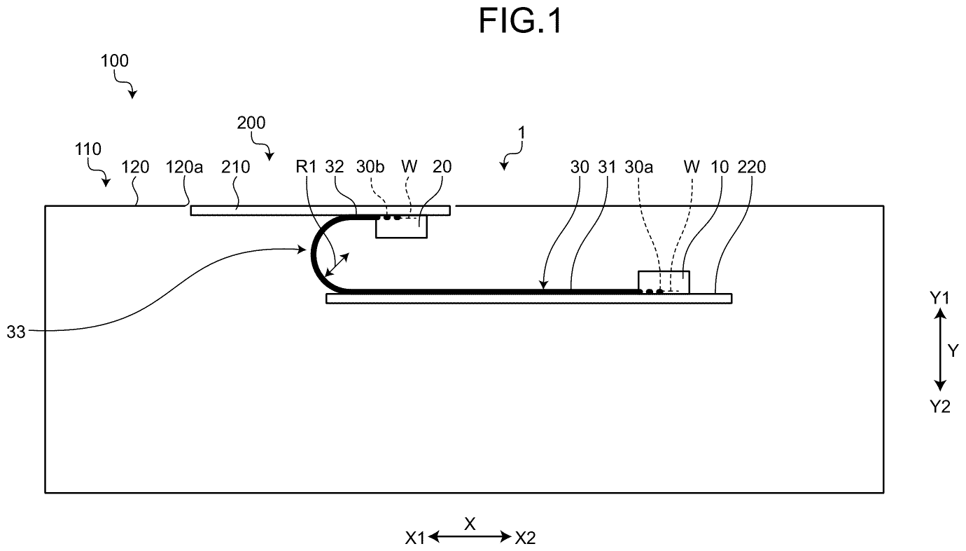

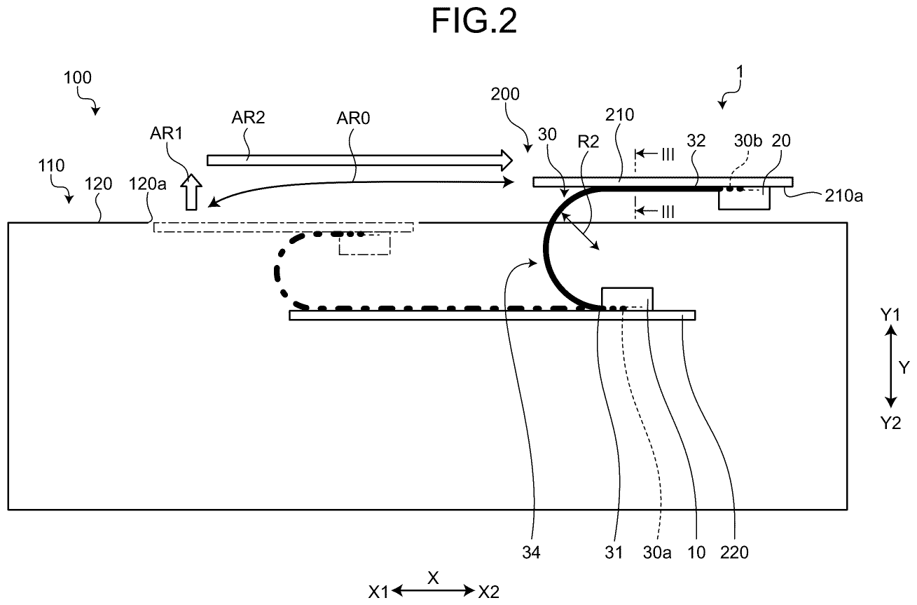

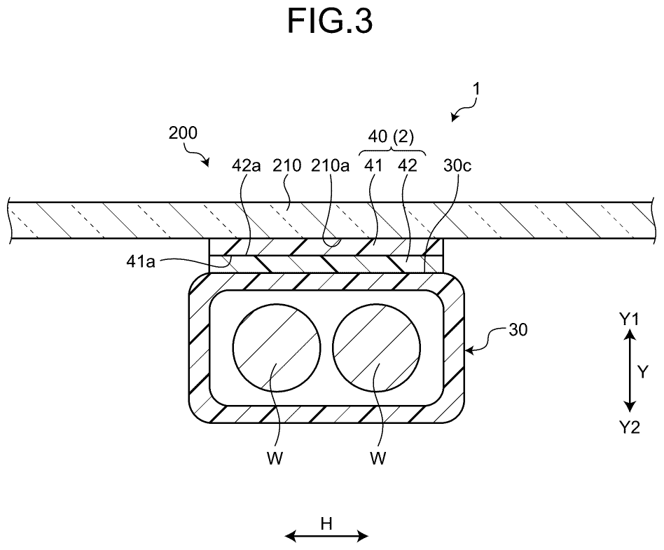

A first embodiment will be described with reference to FIGS. 1 to 3. The present embodiment relates to a routing structure. FIGS. 1 and 2 are side views of a routing structure according to the first embodiment, and FIG. 3 is a cross-sectional view of the routing structure according to the first embodiment. FIG. 3 illustrates a cross section taken along line III-III in FIG. 2.

As illustrated in FIG. 1, the routing structure 1 of the first embodiment is applied to a sunroof 200 of a vehicle 100. The vehicle 100 is, for example, an automobile on which a power source such as a motor or an engine is mounted. The vehicle 100 includes a vehicle body 110. The vehicle body 110 has a roof 120 that covers the vehicle interior. The roof 120 has an opening 120a that opens upward.

The vehicle 100 includes the sunroof 200 that opens and closes the opening 120a. The sunroof 200 includes a slide body 210, a rail 220, and the routing structure 1. The slide body 210 is a member that slides along the first direction X with respect to the vehicle body 110. The illustrated first direction X is a vehicle front-rear direction of the vehicle 100. The slide body 210 of the present embodiment is a plate-like member that closes the opening 120a or opens the opening 120a. The slide body 210 may be glass configured to transmit light.

The sunroof 200 includes a mechanism such as a link mechanism that moves the slide body 210 along a predetermined path, and a drive source such as a motor that operates the above mechanism. The sunroof 200 moves the slide body 210 between a fully closed position where the opening 120a is closed and a fully open position where the opening 120a is opened. FIG. 1 illustrates the slide body 210 at a fully closed position. FIG. 2 illustrates the slide body 210 at a fully open position.

The rail 220 is fixed to the vehicle body 110. The rail 220 extends in the first direction X. The rail 220 supports a mechanism for moving the slide body 210 and guides the mechanism in the first direction X. The rail 220 further supports an exterior member 30 and the exterior member 30 has a rail-side extension portion 31 at the rail 220.

The sunroof 200 of the present embodiment moves the slide body 210 along a path AR0 illustrated in FIG. 2. The movement of the slide body 210 along the path AR0 includes movement in the first direction X and movement in the second direction Y. The second direction Y is a vehicle vertical direction of the vehicle 100. When the slide body 210 moves from the fully closed position to the fully open position, the slide body 210 moves upward Y1 in the second direction Y and moves rearward X2 in the first direction X as indicated by an arrow AR1 in FIG. 2.

Conversely, when the slide body 210 moves from the fully open position to the fully closed position, the slide body 210 moves frontward X1 in the first direction X and moves downward Y2 in the second direction Y.

As illustrated in FIGS. 1 and 2, the routing structure 1 includes a first fixing portion 10, a second fixing portion 20, the exterior member 30, and an electric wire W. The exterior member 30 and the electric wire W constitute a wire harness routed between the vehicle body 110 and the slide body 210.

The first fixing portion 10 is a member fixed to the vehicle body 110 of the vehicle 100. The first fixing portion 10 may be a protector that protects the electric wire W. The first fixing portion 10 is formed of, for example, insulating synthetic resin. The first fixing portion 10 has a space in which the electric wire W is routed and has a holding structure for holding the exterior member 30.

The second fixing portion 20 is a member fixed to the slide body 210 of the sunroof 200. The second fixing portion 20 may be a protector that protects the electric wire W. The second fixing portion 20 is formed of, for example, insulating synthetic resin. The second fixing portion 20 has a space in which the electric wire W is routed and has a holding structure for holding the exterior member 30.

The exterior member 30 is an elastically deformable tubular member. The exterior member 30 is, for example, a member called a corrugated tube. The exterior member 30 is formed of, for example, an insulating synthetic resin. The exterior member 30 may have a bellows shape.

The exterior member 30 has a first end portion 30a held by the first fixing portion 10 and a second end portion 30b held by the second fixing portion 20. The first fixing portion 10 holds the first end portion 30a such that the exterior member 30 extends from the first fixing portion 10 along the rail 220 in the first direction X. In the present embodiment, the first fixing portion 10 holds the first end portion 30a such that the exterior member 30 extends frontward X1 from the first fixing portion 10.

The second fixing portion 20 holds the second end portion 30b such that the exterior member 30 extends from the second fixing portion 20 along the slide body 210 in the first direction X. In the present embodiment, the second fixing portion 20 holds the second end portion 30b such that the exterior member 30 extends frontward X1 from the second fixing portion 20.

The electric wire W is disposed inside the exterior member 30. The electric wire W is, for example, a sheathed electric wire having a stranded wire and a sheath. The electric wire W may be a flat routing member, a printed circuit body, or another circuit body. The electric wire W drawn out from the first end portion 30a is connected to a power supply and a control device disposed in the vehicle body 110. The electric wire W drawn out from the second end portion 30b is connected to a load disposed at the slide body 210. The load disposed at the slide body 210 may be, for example, a lighting device, a light adjusting film disposed on the glass of the slide body 210, or another electric load.

As illustrated in FIGS. 1 and 2, the exterior member 30 has curved portions 33 and 34 that are curved in the first direction X between the first end portion 30a and the second end portion 30b. The curved portion 33 illustrated in FIG. 1 is a curved portion of the exterior member 30 in a state where the slide body 210 is at the fully closed position. The curved portion 33 has a radius R1. The curved portion 34 illustrated in FIG. 2 is a curved portion of the exterior member 30 in a state where the slide body 210 is at the fully open position. The curved portion 34 has a radius R2. The electric wire W in which the curved portions 33 and 34 are formed has a U shape or a J shape.

The second end portion 30b of the exterior member 30 moves together with the slide body 210. At this time, the exterior member 30 follows the movement of the second fixing portion 20 while gradually changing the position where the curved portion is formed.

The routing structure 1 of the present embodiment is configured such that the exterior member 30 is disposed along the slide body 210 by the rigidity of the exterior member 30 and the rigidity of the electric wire W. As illustrated in FIG. 2, when the slide body 210 is at the fully open position, the exterior member 30 has an extension portion 32. The extension portion 32 is a portion, of the exterior member 30, extending along the slide body 210. The extension portion 32 is formed along a vehicle interior side face 210a of the slide body 210. The vehicle interior side face 210a is a face facing downward Y2. When the vehicle interior side face 210a is a flat face, the extension portion 32 is formed linearly. When the vehicle interior side face 210a has a curved shape, the extension portion 32 has a curved shape along the vehicle interior side face 210a. The exterior member 30 further has the rail-side extension portion 31 extending along the rail 220.

The exterior member 30 deformed to have the curved portions 33 and 34 generates a reaction force to press the slide body 210. Similarly, the electric wire W curved inside the exterior member 30 generates a reaction force to press the slide body 210. The exterior member 30 is pressed against the slide body 210 by these reaction forces to form the extension portion 32.

The magnitude of the force for pressing the exterior member 30 to the slide body 210 varies depending on the radii R1 and R2 of the curved portions 33 and 34. More specifically, since the radius R1 of the curved portion 33 is small at the time of full closing illustrated in FIG. 1, the reaction force generated by the rigidity of the exterior member 30 and the electric wire W increases. When fully opened as shown in FIG. 2, the radius R2 of the curved portion 34 is larger than that when fully closed. In this case, the magnitude of the reaction force generated by the rigidity of the exterior member 30 and the electric wire W is smaller than that when fully closed.

When the pressing force that presses the exterior member 30 against the slide body 210 is small, the extension portion 32 may be away from the slide body 210 due to vibration during traveling or the weight of the exterior member 30 or the like. When the extension portion 32 is away from the slide body 210, the exterior member 30 may not smoothly slide when the slide body 210 is moved.

The routing structure 1 of the present embodiment includes a regulating unit 2 described below. The regulating unit 2 is a unit that regulates separation of the extension portion 32 of the exterior member 30 from the slide body 210. The regulating unit 2 of the present embodiment applies a holding force for holding the exterior member 30 on the slide body 210 to the exterior member 30.

As illustrated in FIG. 3, the regulating unit 2 includes a hook-and-loop fastener 40 that adheres the exterior member 30 to the slide body 210. The hook-and-loop fastener 40 includes a first member 41 disposed on the slide body 210 and a second member 42 disposed on the exterior member 30. The first member 41 and the second member 42 illustrated are tape members. The first member 41 and the second member 42 extend in a width direction H in the cross section. The width direction H is, for example, a vehicle width direction of the vehicle 100. The first member 41 is fixed to the vehicle interior side face 210a of the slide body 210.

The second member 42 is fixed to a facing surface 30c of the exterior member 30. The facing surface 30c is a face facing the vehicle interior side face 210a in the second direction Y. The exterior member 30 of the present embodiment has a rectangular cross-sectional shape. That is, the exterior member 30 has a rectangular tube shape. The facing surface 30c constitutes one side of a rectangle in the cross section of the exterior member 30.

The second member 42 extends along the axis direction of the exterior member 30. The second member 42 is disposed in a range where at least the extension portion 32 is formed in the exterior member 30. That is, the second member 42 is disposed in the range of the extension portion 32 in FIG. 2.

The first member 41 is disposed in a range corresponding to the extension portion 32 of the slide body 210. That is, the first member 41 is disposed such that the entirety of the extension portion 32 can be adhered to the slide body 210.

As shown in FIG. 3, the first member 41 has an adhesion face 41a, and the second member 42 has an adhesion face 42a. The adhesion face 41a is a face, of the first member 41, facing the exterior member 30. The adhesion face 42a is a face, of the second member 42, facing the slide body 210. The adhesion faces 41a and 42a are configured to adhere to each other. In addition, the adhesion faces 41a and 42a are configured to be peeled off when separated by a predetermined force. The peeled adhesion faces 41a and 42a can adhere to each other again. That is, the first member 41 and the second member 42 are configured such that adhesion and peeling off can be repeated.

When the slide body 210 moves from the fully closed position toward the fully open position, the exterior member 30 is pressed against the slide body 210 by the rigidity of the exterior member 30 and the electric wire W. Accordingly, along with the movement of the slide body 210 rearward X2, the second member 42 adheres to the first member 41 in order from the second end portion 30b. When the slide body 210 moves to the fully open position, the second member 42 adheres to the first member 41 over the entire length of the extension portion 32.

The hook-and-loop fastener 40 holds the extension portion 32 on the slide body 210 by an adhesive force of the first member 41 and the second member 42, and suppresses sagging of the extension portion 32 and vibration of the extension portion 32. The routing structure 1 of the present embodiment can regulate the separation of the extension portion 32 from the slide body 210 even when the rigidity of the exterior member 30 and the electric wire W is small. In other words, in the routing structure 1 of the present embodiment, the extension portion 32 can be held by the slide body 210 even if the reaction force generated by the curved portion 34 is small.

When the slide body 210 moves from the fully open position toward the fully closed position, the position of the curved portion in the exterior member 30 changes so as to approach the second end portion 30b. Due to the change in the position of the curved portion, the length of the extension portion 32 gradually decreases. At this time, in the portion that newly is the curved portion, the extension portion 32 is pulled away from the slide body 210 by the rigidity of the exterior member 30 and the electric wire W. Accordingly, the second member 42 is separated from the first member 41 as the slide body 210 moves frontward X1.

Part of the first member 41 and part of the second member 42 may adhere to each other in a state where slide body 210 is at the fully closed position. With such a configuration, vibration and sagging of the wire harness at the time of full closing are suppressed.

As described above, the routing structure 1 of the present embodiment includes the first fixing portion 10, the second fixing portion 20, the exterior member 30, the electric wire W, and the regulating unit 2. The first fixing portion 10 is fixed to the vehicle body 110 of the vehicle 100. The second fixing portion 20 is fixed to the slide body 210 that slides along the first direction X with respect to the vehicle body 110. The first direction X is an example of a predetermined direction in which the slide body moves. The exterior member 30 includes the first end portion 30a held by the first fixing portion 10, the second end portion 30b held by the second fixing portion 20, and curved portions 33 and 34 curved in the first direction X between the first end portion 30a and the second end portion 30b. The electric wire W is disposed inside the exterior member 30.

The second fixing portion 20 holds the second end portion 30b such that the exterior member 30 extends from the second fixing portion 20 along the slide body 210 in the first direction X. The regulating unit 2 is a unit that regulates separation of the extension portion 32 of the exterior member 30 from the slide body 210. The regulating unit 2 applies a holding force for holding the exterior member 30 on the slide body 210 to the exterior member 30. Therefore, the routing structure 1 of the present embodiment can stabilize the shape of the exterior member 30 by regulating the separation of the extension portion 32 from the slide body 210.

The regulating unit 2 of the present embodiment includes a hook-and-loop fastener 40 that adheres the exterior member 30 to the slide body 210. The holding force for holding the exterior member 30 on the slide body 210 is an adhesive force of the hook-and-loop fastener 40. The hook-and-loop fastener 40 can effectively suppress vibration of the exterior member 30 and sagging of the exterior member 30.

Note that the slide body 210 in the sunroof 200 is not limited to glass. The slide body 210 may be a frame disposed on glass, a support member that supports glass, or another sliding member.

The slide body 210 is not limited to the member of the sunroof 200. The slide body 210 may be, for example, a door that slides with respect to the vehicle body 110. The slide body 210 may be a seat that slides with respect to the vehicle body 110. The routing structure 1 is applicable to various slide bodies 210 disposed in the vehicle 100.

### Second Embodiment

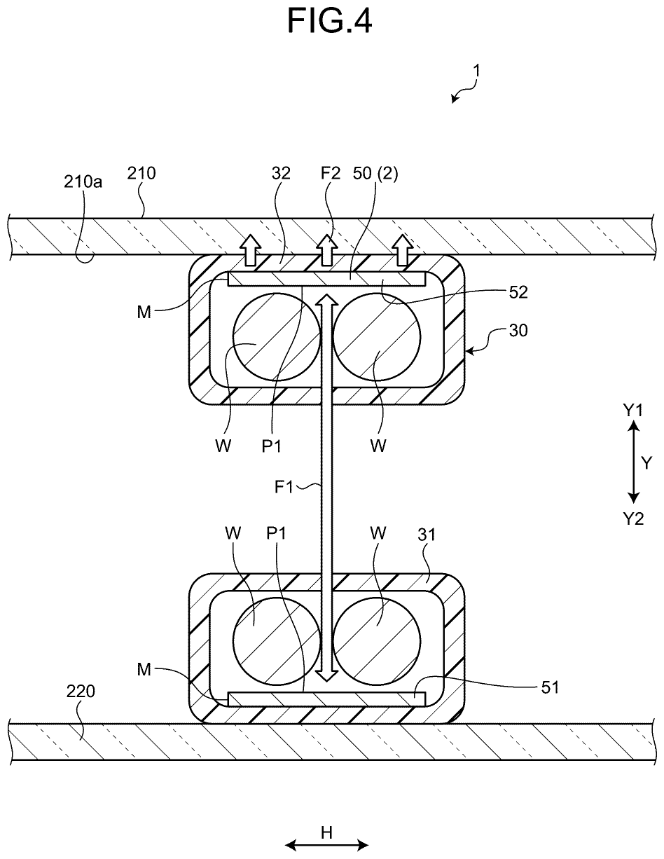

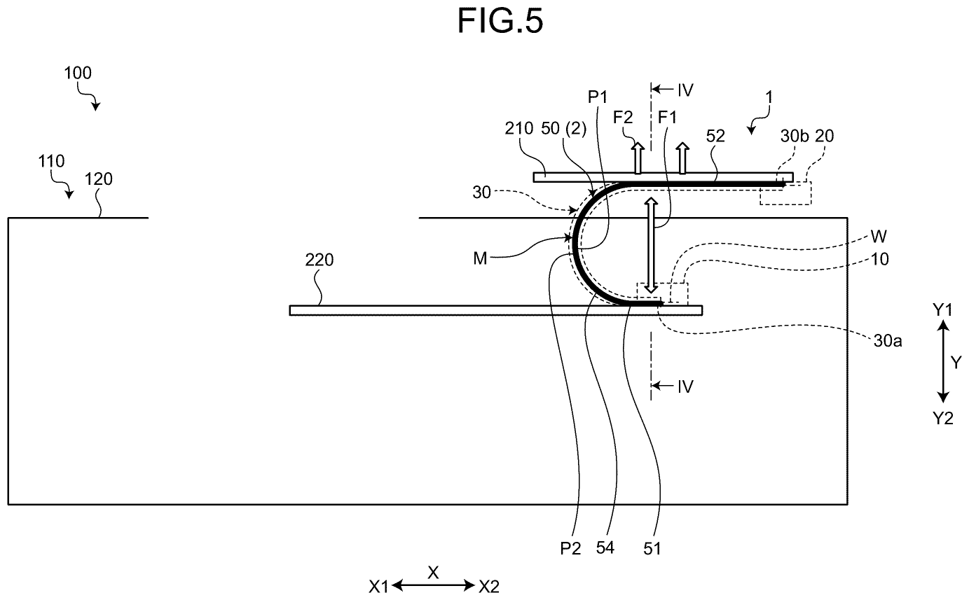

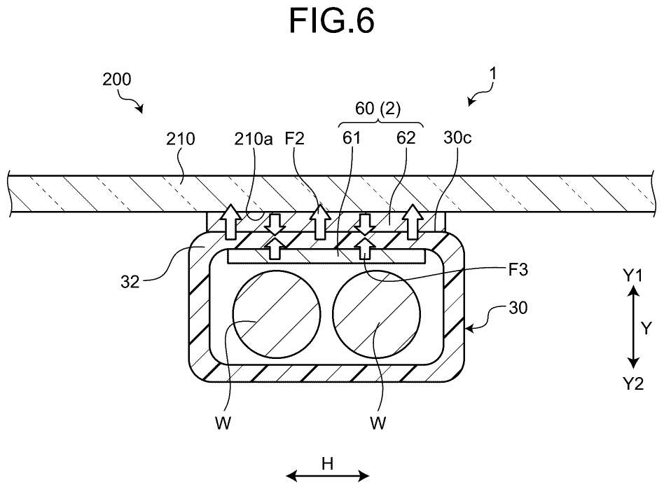

A second embodiment will be described with reference to FIGS. 4 to 6. In the second embodiment, components having functions similar to those described in the first embodiment are denoted by the same reference numerals, and redundant description is omitted. FIG. 4 is a cross-sectional view of the routing structure according to the second embodiment, FIG. 5 is a side view of the routing structure according to the second embodiment, and FIG. 6 is a cross-sectional view of another routing structure according to the second embodiment. FIG. 4 illustrates a cross section taken along line IV-IV in FIG. 5. The routing structure 1 of the second embodiment is different from the routing structure 1 of the first embodiment in that, for example, the exterior member 30 is pressed against the slide body 210 by a magnetic force.

The regulating unit 2 illustrated in FIGS. 4 and 5 includes an urging member 50 instead of the hook-and-loop fastener 40 of the first embodiment. In FIG. 5, the exterior member 30 and the fixing portions 10 and 20 are indicated by broken lines in order to facilitate understanding of the shape of the urging member 50.

The urging member 50 is a plate-like or rod-like member having rigidity. The urging member 50 is made of metal, resin, or the like. The shape of the urging member 50 is, for example, a round bar shape or a flat plate shape. The urging member 50 is disposed inside the exterior member 30 from the first fixing portion 10 to the second fixing portion 20.

FIG. 5 illustrates the urging member 50 when the slide body 210 is in the fully open position. The urging member 50 has a curved portion 54 similar to the curved portion 34 of the exterior member 30. The urging member 50 deformed to have a curved shape presses the exterior member 30 against the slide body 210.

The urging member 50 is configured to be able to generate a magnetic force. For example, the urging member 50 may include a magnet M. Alternatively, the urging member 50 may include a rod-like or plate-like main body and the magnet M fixed to the main body. The magnet M is disposed over the entire length of the urging member 50, for example. As illustrated in FIG. 5, the magnet M of the urging member 50 has a first pole P1 and a second pole P2. One of the first pole P1 and the second pole P2 is an N pole, and the other of the first pole P1 and the second pole P2 is an S pole.

The first pole P1 of the magnet M is disposed so as to be located at the inner side of the curved shape of the curved portion 54, and the second pole P2 of the magnet M is disposed so as to be located at the outer side of the curved shape of the curved portion 54. When the slide body 210 is in the fully open position, the urging member 50 has a first extension portion 51 and a second extension portion 52. The first extension portion 51 is a portion extending along the rail 220. The second extension portion 52 is a portion extending along the slide body 210. The first extension portion 51 and the second extension portion 52 face each other in the second direction Y.

As illustrated in FIG. 4, the first pole P1 of the magnet M of the first extension portion 51 and the first pole P1 of the magnet M located at the second extension portion 52 face each other in the second direction Y. Therefore, a repulsive force F1 due to the magnetic force acts on the first extension portion 51 and the second extension portion 52. The repulsive force F1 is a force in the second direction Y and is a force in a direction in which the extension portion 32 and the rail-side extension portion 31 of the exterior member 30 are away from each other. Therefore, a pressing force F2 for pressing the extension portion 32 of the exterior member 30 against the slide body 210 is applied. The pressing force F2 can regulate separation of the exterior member 30 from the slide body 210.

In this manner, the urging member 50 applies the pressing force based on the rigidity of the urging member 50 and the pressing force F2 by the magnetic force to the exterior member 30. Therefore, the urging member 50 can suppress separation of the exterior member 30 from the slide body 210, and can stabilize the shape of the exterior member 30.

Note that the regulating unit 2 may press the exterior member 30 against the slide body 210 by a magnetic attractive force. FIG. 6 illustrates an attraction unit 60 according to the second embodiment. The attraction unit 60 is an example of the regulating unit 2 that uses a magnetic force. The attraction unit 60 includes a first member 61 and a second member 62. The first member 61 and the second member 62 are, for example, rod-like or plate-like members. The exemplified first member 61 and second member 62 have a flat plate shape. The first member 61 is disposed on the exterior member 30, and the second member 62 is disposed on the slide body 210.

The illustrated first member 61 is disposed inside the exterior member 30. The first member 61 is, for example, a member having a magnet similar to the urging member 50. The first member 61 is disposed over the entire length of the exterior member 30, for example. The magnet of the first member 61 may be disposed in a range where the exterior member 30 forms the extension portion 32.

The exemplified second member 62 is fixed to the vehicle interior side face 210a of the slide body 210. The second member 62 is configured to generate an attractive force F3 by a magnetic force between the second member 62 and the first member 61. When the first member 61 has a magnet, the second member 62 may be a magnetic body or may have a magnet. By the attractive force F3 acting on the first member 61, the pressing force F2 that presses the exterior member 30 against the slide body 210 acts on the exterior member 30.

When the second member 62 has a magnet, the first member 61 may be a magnetic body. That is, one of the first member 61 and the second member 62 may have a magnet, and the other may be configured to be attracted by the magnetic field of the magnet.

Instead of adding the second member 62 to the slide body 210, part of the slide body 210 may be made of a magnetic body. For example, when the slide body 210 includes a glass plate and a frame that holds the glass plate, the frame may be made of a magnetic body. In this case, the exterior member 30 is disposed so as to face the frame of the magnetic body. The first member 61 disposed inside the exterior member 30 has a magnet. The first member 61 having a magnet is attracted to the slide body 210 by an attractive force by a magnetic force.

As described above, the regulating unit 2 of the second embodiment applies the pressing force F2 by the magnetic force that presses the exterior member 30 against the slide body 210 to the exterior member 30. Therefore, the routing structure 1 of the second embodiment can stabilize the shape of the exterior member 30.

The regulating unit 2 of the present embodiment includes the urging member 50. The urging member 50 includes a magnet disposed inside the exterior member 30. The pressing force F2 for pressing the exterior member 30 against the slide body 210 is the repulsive force F1 due to a magnetic force acting between the magnet M located at the first end portion 30a and the magnet M located at the second end portion 30b of the exterior member 30. The urging member 50 can stabilize the shape of the exterior member 30 by pressing the exterior member 30 against the slide body 210 by the repulsive force F1. The urging member 50 and the hook-and-loop fastener 40 of the first embodiment may be combined.

### MODIFICATIONS

Modifications of the first embodiment and the second embodiment will be described. The rigidity of the electric wire W may be increased as a configuration of improving the force of pressing the extension portion 32 against the slide body 210. For example, the size such as the diameter of the conductor of the electric wire W may be increased. For example, the size such as the thickness of the insulator of the electric wire W may be increased. For example, a rib may be added to the insulator of the electric wire W.

A portion, of the electric wire W, where the curved portion 34 when fully opened is formed may have large rigidity. For example, rigidity of a portion, of the electric wire W, where the curved portion 33 when fully opened is formed may be larger than rigidity of a portion, of the electric wire W, where the curved portion 34 when fully closed is formed. In this case, rigidity may be increased by providing a rib in a portion where the curved portion 34 is formed.

The content disclosed in the above embodiments and modifications can be appropriately combined and executed.

The regulating unit of the routing structure according to the present embodiment regulates separation of a portion, of the exterior member, extending along the slide body from the slide body. The regulating unit applies to the exterior member at least one of a pressing force that presses the exterior member against the slide body and a holding force for holding the exterior member on the slide body. According to the routing structure of the present embodiment, there is an effect that the shape of the exterior member can be stabilized.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A routing structure comprising:
a first fixing portion fixed to a vehicle body of a vehicle;
a second fixing portion fixed to a slide body that slides along a predetermined direction with respect to the vehicle body;
an exterior member having a first end portion held by the first fixing portion, a second end portion held by the second fixing portion, and a curved portion curved in the predetermined direction between the first end portion and the second end portion;
an electric wire disposed inside the exterior member; and
a regulating unit, wherein
the second fixing portion holds the second end portion such that the exterior member extends from the second fixing portion along the slide body in the predetermined direction,
the regulating unit regulates separation of a portion, of the exterior member, extending along the slide body from the slide body, and
the regulating unit applies, to the exterior member, at least one of a pressing force generated by a magnetic force, the pressing force pressing the exterior member against the slide body and a holding force that holds the exterior member on the slide body.

2. The routing structure according to claim 1, wherein
the regulating unit includes a hook-and-loop fastener that adheres the exterior member to the slide body, and
a holding force that holds the exterior member on the slide body is an adhesive force of the hook-and-loop fastener.

3. The routing structure according to claim 1, wherein
the regulating unit includes a magnet disposed inside the exterior member, and
a pressing force that presses the exterior member against the slide body is a repulsive force due to a magnetic force acting between the magnet positioned close to the first end portion and the magnet positioned close to the second end portion.
